(19) United States
(12) Patent Application Publication
(10) Pub. No.: US 2020/0142392 A1
(43) Pub. Date: May 7, 2020

(54) SYSTEM AND METHOD FOR PREDICTING BEARING LIFE

(71) Applicant: General Electric Company, Schenectady, NY (US)

(72) Inventors: Rahul Srinivas PRABHU, Bangalore (IN); Hombe GOWDA, Bangalore (IN); Souvik MATH, Bangalore (IN); Venkatesh Kattigari MADYASTHA, Bangalore (IN)

(21) Appl. No.: 15/185,062

(22) Filed: Jun. 17, 2016

(51) Int. Cl. G05B 23/02; G05B 13/04; B61C 17/10

(52) U.S. Cl. CPC G05B 23/0283; B61C 17/10; G05B 13/048; G05B 23/0294

(57) ABSTRACT

A method for predicting a remaining useful life of a bearing involves obtaining a plurality of sets of actual inspection data from the bearing. The method involves obtaining an estimated wear rate from a physics based model of the bearing. The method further involves adjusting the estimated wear rate based on the plurality of sets of actual inspection data to compute an actual wear rate. The method also involves computing a calibration parameter based on the actual wear rate. The method further involves predicting a remaining useful life of the bearing based on the calibration parameter.

### BACKGROUND

Embodiments of the present invention generally relate to bearings and, more particularly, to a system and method for predicting life of a bearing.

Bearings are machine elements that constrain relative motion and reduce friction between moving parts. Various types of bearings are employed in different applications for operating mechanical systems. One such type of a bearing includes a journal bearing which is designed to reduce friction by supporting radial loads and is used in situations where motion is relatively continuous for example, such as crankshafts. The journal bearings are commonly used in locomotives and rail road applications in which a crankshaft rotates freely in a supporting metal sleeve or a shell.

During operation of locomotives, journal bearings sustain wear over a period of time, which require monitoring to avoid breakdowns, component malfunction, or the like. One approach to monitor wear of the journal bearing is to perform an oil based inspection of the bearing. In such an approach, a concentration of metal particles worn out from the bearing, in the oil is measured. A wear rate of the journal bearing is computed based on the measured concentration of the metal particles. The computed wear rate is used to monitor the wear of the journal bearing and is further used to predict a remaining useful life of the journal bearing. In order to further improve an accuracy of prediction of the remaining useful life of the journal bearing, other failure modes may also be considered during computation of the wear rate and the remaining useful life of the journal bearing.

Accordingly, there is a need for an improved system and method for enhancing the accuracy of prediction of a remaining useful life of a journal bearing.

### BRIEF DESCRIPTION

Briefly, in accordance with one embodiment, a method for predicting a remaining useful life of a bearing is disclosed. The method involves obtaining a plurality of sets of actual inspection data from a bearing. The method also involves obtaining an estimated wear rate from a physics based model of the bearing. The method further involves adjusting the estimated wear rate based on the plurality of sets of actual inspection data to compute an actual wear rate. The method also involves computing a calibration parameter based on the actual wear rate. The method further involves predicting a remaining useful life of the bearing based on the calibration parameter.

In another embodiment, a system for predicting a remaining useful life of a bearing is disclosed. The system includes a processor and a controlling module stored in a memory and executable by the processor. The controlling module is configured to obtain a plurality of sets of actual inspection data from the bearing and an estimated wear rate from a physics based model of the bearing. The controlling module is further configured to adjust the estimated wear rate based on the plurality of sets of actual inspection data to compute an actual wear rate and compute a calibration parameter based on the actual wear rate. The system also includes a prediction module stored in the memory and executable by the processor, wherein the prediction module is configured to predict a remaining useful life of the bearing based on the calibration parameter.

In yet another embodiment, a non-transitory computer readable medium, having instructions stored thereon which, when executed using a processor, causes a controlling module and a prediction module stored in the memory to perform a method. The method involves obtaining a plurality of sets of actual inspection data from a bearing. The method further involves obtaining an estimated wear rate from a physics based model of the bearing. The method also involves adjusting the estimated wear rate based on the plurality of sets of actual inspection data to compute an actual wear rate. The method further involves computing a calibration parameter based on the actual wear rate and predicting a remaining useful life of the bearing based on the calibration parameter.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram representative of a system for predicting a remaining useful life of a bearing in accordance with an embodiment of the invention; and

FIG. 2 is a flow chart representative of a plurality of steps involved in a method for predicting a remaining useful life of a bearing in accordance with an embodiment of the invention.

### DETAILED DESCRIPTION

Embodiments of the present invention include a system and method for predicting a remaining useful life of a bearing. The system includes a processor which executes a controlling module stored in a memory to obtain a plurality of sets of actual inspection data from the bearing and an estimated wear rate from a physics based model of the bearing. The controlling module is also configured to adjust the estimated wear rate based on the plurality of sets of actual inspection data to compute an actual wear rate. The controlling module further computes a calibration parameter based on the actual wear rate. The processor further executes a prediction module stored in the memory to predict a remaining useful life of the bearing based on the calibration parameter.

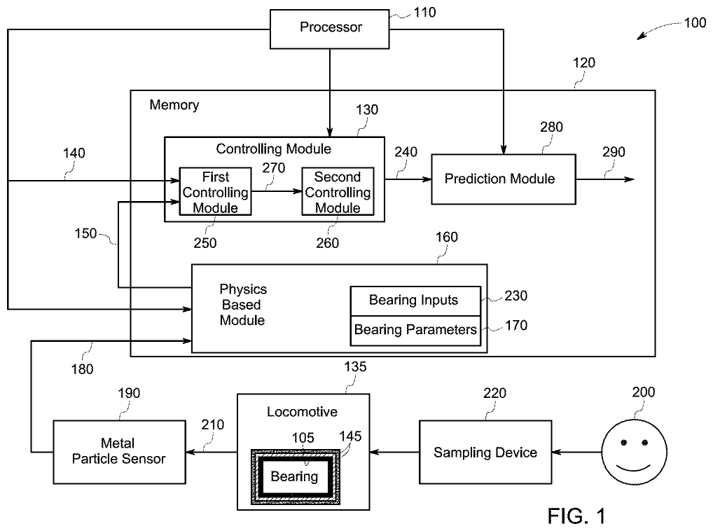

FIG. 1 is a block diagram representative of a system 100 for predicting a remaining useful life of a bearing 105 in accordance with an embodiment of the invention. The system 100 includes a processor 110 configured to execute a module stored in a memory 120. As used herein, the term “processor” may include at least one arithmetic logic unit, microprocessor, general purpose controller or other processor arrays to perform computations, and/or retrieve data stored in the memory 120. In one embodiment, the processor 110 may be a multiple core processor. The processor 110 is configured to process data signals and may include various computing architectures including a complex instruction set computer (CISC) architecture, a reduced instruction set computer (RISC) architecture, or an architecture implementing a combination of instruction sets. In one embodiment, the processing capability of the processor 110 may be limited to supporting the retrieval of data and transmission of data. In another embodiment, the processing capability of the processor 110 may also perform more complex tasks including various types of feature extraction, modulating, encoding, multiplexing, and the like. Other type of processors, operating systems, and physical configurations are also envisioned. As used herein, the term “memory” may be a non-transitory storage medium. For example, the memory 120 may be a dynamic random access memory (DRAM) device, a static random access memory (SRAM) device, flash memory, or other memory devices. The memory 120 may also include a non-volatile memory or a similar permanent storage device, and media such as a hard disk drive, a floppy disk drive, a compact disc read only memory (CD-ROM) device, a digital versatile disc read only memory (DVD-ROM) device, a digital versatile disc random access memory (DVD-RAM) device, a digital versatile disc rewritable (DVD-RW) device, a flash memory device, or other non-volatile storage devices.

The system 100 further includes a controlling module 130 which is stored in the memory 120 and executable by the processor 110. The processor 110 executes the controlling module 130 to obtain a plurality of sets of actual inspection data 140 from the bearing 105. As used herein, the term “a set of actual inspection data” may be defined as data collected by a user 200 upon manual inspection of the bearing 105. In one embodiment, the set of actual inspection data 140 may include a failure mode data that is collected by the user 200 upon manual inspection of the bearing 105. In a specific embodiment, the failure mode data may include a crack data, a creep data, a tribology data, a corrosion data and an actual change in thickness of one or more layers 145 of the bearing 105 from a predefined thickness. As discussed herein, the crack data and the creep data relates to a measurement and a condition of a crack and a creep that originates in the bearing 105. In a specific embodiment, upon manual inspection of the bearing 105, the crack data may be measured using a Vernier caliper. The tribology data may relate to wear of the bearing 105 due to friction and lubrication in the bearing 105. The corrosion data may be defined as a data related to corrosion of the bearing 105. In a specific embodiment, the corrosion data may be obtained using a pit depth gauge during manual inspection of the bearing 105. The actual change in thickness of the one or more layers 145 of the bearing 105 is obtained upon manual inspection of the bearing 105, where the change in thickness of the one or more layers 145 is computed with respect to the predefined thickness of the bearing 105. The predefined thickness of one or more layers 145 of the bearing 105 may be known to the user 200 or may be obtained from available specifications of the bearing 105. The bearing 105 is formed of one or more layers 145 of a metallic composition that includes predefined concentrations of one or more metals, having a predefined thickness. During operation of the bearing 105, the one or more layers 145 of the bearing 105 erode over time, which is measured as the change in thickness of the one or more layers 145 of the bearing 105. Crack data, creep data, and the actual change in thickness of the one or more layers 145 among others, form a set of the actual inspection data 140.

In some embodiments, the bearing 105 may include a journal bearing disposed in a locomotive 135. In a specific embodiment, the journal bearing may include a trimetal bearing, or a sputtered bearing, or a Rillenlager bearing. In one embodiment, the plurality of sets of actual inspection data 140 may be obtained at different intervals of time from the journal bearing disposed in the locomotive 135. In another embodiment, the plurality of sets of actual inspection data 140 may be obtained from a plurality of journal bearings disposed in a plurality of locomotives 135. In a specific embodiment, the plurality of sets of actual inspection data 140 is obtained from the plurality of journal bearings disposed in a fleet of the plurality of locomotives 135. In a more specific embodiment, the plurality of sets of actual inspection data 140 is obtained from the plurality of journal bearings disposed in a same fleet of locomotives 135.

The plurality of sets of actual inspection data 140 may be obtained by various methods. In one embodiment, the plurality of sets of actual inspection data 140 may be obtained from one bearing at different intervals of time. For example, the plurality of sets of actual inspection data 140 may be obtained from one bearing 105 at a first time interval (for example, after completion of three months of operation of the bearing 105 from a predefined date) and then at a subsequent time interval (for example, after completion of six months of operation of the bearing 105 from the predefined date). In another embodiment, the plurality of sets of actual inspection data 140 may be obtained from a plurality of bearings 105 at the same time interval. For example, the plurality of sets of actual inspection data 140 may be obtained from the plurality of bearings 105 after completion of three months of operation of the bearings from a predefined date. In yet another embodiment, the plurality of sets of actual inspection data 140 may be obtained from a plurality of bearings 105 at different intervals of time. For example, the plurality of sets of actual inspection data 140 may be obtained from the plurality of bearings 105 at a first time interval (for example, after completion of three months of operation of the plurality of bearings 105 from a predefined date) and then at a subsequent time interval (for example, after completion of six months of operation of the plurality of bearings 105 from the predefined date).

Further, the controlling module 130 obtains an estimated wear rate 150 from a physics based model 160 of the bearing 105. As used herein, the term “estimated wear rate” may be defined as a rate of wear of the bearing 105 computed by the physics based model based on the process described below in detail. The physics based model 160 may be stored in the memory 120 and may be executed by the processor 110 to generate the estimated wear rate 150. In another embodiment, the physics based model 160 may be stored in a separate memory and may be executed by the same processor 110 or a separate processor. The physics based model 160 obtains a concentration of the one or more metal particles eroded from the bearing 105, in a fluid, for diagnostic purposes, prognostic purposes, or a combination thereof. In one embodiment, the fluid may include lubrication oil. The physics based model 160 may include predefined bearing parameters 170 of the bearing 105. In one embodiment, the predefined bearing parameters 170 may include different types of bearing, metals used for manufacturing each type of bearing, concentration of each metal in each type of bearing. In another embodiment, the physics based model 160 further includes a predefined metal particle concentration threshold in parts per million for each type of bearing.

The physics based model 160 obtains a concentration of one or more eroded metal particles 180 in the fluid, from a metal particle sensor 190. In one embodiment, the user 200 may obtain a sample 210 of the fluid, using a sampling device 220 prior to determining the concentration of the one or more eroded metal particles 180. Volume of the sample 210 obtained by the user 200, may vary based on a type of fluid, a type of bearing, a type of application, a type of metal particle sensor, or a combination thereof. In one embodiment, a predetermined volume of the sample 210 may be fifty milliliters. In another embodiment, a plurality of samples 210 may be obtained prior to determining the concentration of the one or more particles 180. Subsequently, the metal particle sensor 190 is used to determine the concentration of the one or more metal particles 180 in the fluid sample. In one embodiment, the metal particle sensor 190 may include an inductively coupled plasma optical emission spectroscope having a rotating disk electrode, or an inductively coupled plasma mass spectrometer, or a laser induced breakdown spectroscope, or an X-ray fluorescence device. The metal particle sensor 190 is configured to sense the presence of a plurality of metal particles in the sample 210 and determine the concentration of one or more metal particles 180 in parts per million. The aforementioned steps is repeated for each of the plurality of samples 210 and an average concentration of the one or more metal particles is determined, which is then transmitted to the physics based model 160.

In certain embodiments, where the bearing 105 is a journal bearing disposed in the locomotive 135, such a bearing is exposed to a high temperature and a high pressure during operation. The high temperature and the high pressure lead to erosion of one or more metal particles from the journal bearing. Such erosion from the journal bearing leads to concentration of one or more metal particles 180 in the fluid, for example, an engine oil. The user 200 obtains the sample 210 of the engine oil from the locomotive 135 and then uses the metal particle sensor 190 to determine the concentration of the one or more metal particles 180 eroded from the journal bearing, in the engine oil. In one embodiment, the one or more particles may include lead, copper, aluminum, tin, antimony, or a combination thereof. Specifically, the metal particle sensor 190 determines the concentration of one or more metal particles 180 eroded from the journal bearing, in parts per million and then transmits the concentration of the one or more metal particles 180 to the physics based model 160. As discussed earlier, the physics based model 160 includes the bearing parameters 170 which include predefined bearing details such as type of bearing, for example, journal bearing. The bearing parameters 170 include the list of metals used for manufacturing the journal bearings such as lead (Pb), tin (Sr), copper (Cu), and Aluminum (Al). In one embodiment, the bearing parameters 170 include predefined metal concentration thresholds for the journal bearing, (for example, trimetal and sputtered type bearings) as shown in table 1 below.

TABLE 1

| | Predefined metal | Predefined metal |
|---|---|---|
| | concentration | concentration |
| | threshold for | threshold for |
| | Trimetal Journal Bearing | Sputtered Journal Bearing |
| Metal | (in PPM) | (in PPM) |
| Lead (Pb) | 15 | 2 |
| Tin (Sn) | 0.2 | 0.2 |
| Aluminum (Al) | 4 | 10 |
| Copper (Cu) | 15 | NIL |

The physics based model 160 compares the concentration of each of the one or more metal particles 180 obtained from the metal particle sensor 190 with a corresponding predefined metal concentration threshold. If the concentration of each of the one or more metal particles 180 is greater than the corresponding predefined metal concentration threshold, the physics based model 160 estimates a change in thickness of one or more layers in the journal bearing from a predefined thickness, based on the concentration of one or more metal particles 180 in the fluid. Extent of erosion of the one or more layers 145 of the bearing 105, is determined based on the concentration of one or eroded metal particles 180 in the fluid. The physics based model 160 computes the change in thickness of the one or more layers 145 in the bearing 105 from a predefined thickness and computes the estimated wear rate 150 based on the computed change in thickness as discussed in greater below.

The physics based model 160 further includes one or more bearing inputs 230. The one or more bearing inputs 230 may either be stored in the physics based model 160 or may be computed by the physics based model 160. For example, the one or more bearing inputs 230 for the journal bearing in the locomotive 135, may include a journal bearing geometry, metallic composition properties, engine oil properties, an operating time of the locomotive 135, a duty cycle of the locomotive 135, an average load of the locomotive 135 during operating time, an average velocity of the locomotive 135 during operating time, a bearing hardness, an engine oil temperature, an average pressure on the journal bearing, Young's modulus of the journal bearing, and a bearing layer volume.

The physics based model 160 determines a fluid pressure on the bearing 105 based on the one or more bearing inputs 230. The physics based model 160 computes a fluid film pressure based on the Reynold's equation:

$$\frac{\partial }{\partial x} ( \frac{ρ {h}^{3}}{12 μ} \frac{\partial p}{\partial x} ) + \frac{\partial }{\partial y} ( \frac{ρ {h}^{3}}{12 μ} \frac{\partial p}{\partial y} ) - {u}_{m} \frac{\partial }{\partial x} ( ρ h ) - \frac{\partial }{\partial t} ( ρ h ) = 0 \qquad ( 1 )$$

where, p is fluid film pressure, x and y are bearing width and length coordinates, h is fluid film thickness, μ is fluid viscosity, ρ is fluid density, u is the bounding body velocity, m is subscript denoting bounding bodies, t is time coordinate.

The physics based model 160 further computes a fluid film thickness h based on the equation:

$$h ( x , y , t ) = c + e ( t ) cos ( \frac{x}{R} ) + \frac{2}{π E} \int {\int }_{- ∞}^{∞} \frac{p ( {x}^{′} , {y}^{′} , t ) \partial {x}^{′} \partial {y}^{′}}{√ {( x - {x}^{′} )}^{2} + {( y - {y}^{′} )}^{2}} \qquad ( 2 )$$

where h is fluid film thickness, c is radial clearance, e is eccentricity, R is bearing radius, E is combined modulus,

$$\int {\int }_{- ∞}^{∞} \frac{p ( {x}^{′} , {y}^{′} , t ) \partial {x}^{′} \partial {y}^{′}}{√ {( x - {x}^{′} )}^{2} + {( y - {y}^{′} )}^{2}}$$

is Boussinesq and Cerruti integral, p is fluid film pressure, x and y are bearing width and length coordinates, t is time coordinate.

Furthermore, the physics based model 160 computes a fluid temperature T based on the equation:

$${pC}_{p} ( u \frac{\partial T}{\partial x} + v \frac{\partial T}{\partial y} + \frac{\partial T}{\partial t} ) = \frac{\partial }{\partial z} ( {k}_{f} \frac{\partial T}{\partial z} ) + β T ( u \frac{\partial p}{\partial x} + v \frac{\partial p}{\partial y} ) + μ [ {( \frac{\partial u}{\partial z} )}^{2} + {( \frac{\partial v}{\partial z} )}^{2} ] \qquad ( 3 )$$

where ρ denotes fluid density, μ represents fluid viscosity, β represents thermal expansivity, Cₚ represents specific heat of the fluid, K_{f} represents thermal conductivity of the fluid, u, v are the fluid velocities in x, y directions respectively, T is fluid temperature, p is fluid pressure, h is film thickness, x, y, z are coordinates along circumference, length and film thickness, and t is time coordinate.

The physics based model 160 computes a function of a probability of contact (Fₙ(λ)) between a shaft and the bearing 105 based on the fluid film thickness, where Fₙ(λ) is represented as:

Fₙ(λ)=∫_{λ}^{∞}(s−λ)ⁿϕ*(s)∂s (4)

where ϕ*(s) is standardized height distribution of asperity pressure. For a Gaussian surface ϕ*(s) may be represented as:

$${φ}^{*} ( s ) = \frac{1}{\sqrt{2 π}} {e}^{- \frac{1}{2} s 2} \qquad ( 5 )$$

and λ is represented by hₛ/Rq, where hₛ is separation between surfaces of the bearing 105 and the shaft and R_{q} is root mean square of surface roughness of the bearing 105 and the shaft.

In situations, where λ is greater than or equal to four, then Fₙ(λ) is computed as zero, which represents a situation where the thickness of the fluid in contact with the bearing 105 is greater than or equal to a threshold thickness and the probability of contact between the shaft and the bearing 105 is zero which results in zero erosion. However, if the value of λ is less than four, Fₙ(λ) is computed as:

F_{5/2}(λ)=4.4086*10⁻⁵*(4−λ)^{6.804} (6)

Furthermore, the physics based model 160 computes a contact pressure/asperity pressure based on the computed Fᵢₜ(2) and the below equation:

p_{c}=KE*F_{5/2}(λ) (7)

where E* is composite Young's modulus and E* is computed by:

$${E}^{*} = \frac{1}{( \frac{1 - v {1}^{2}}{{E}_{1}} ) + ( \frac{1 - v {2}^{2}}{{E}_{2}} )} \qquad ( 8 )$$

where ν1, ν2 are poisson ratio of the fluid and the bearing 105 respectively, E1, E2 are Young's modulus of the fluid and the bearing 105 respectively, and K is a surface parameter of surface roughness, asperity pressure, and asperity density, which is computed by the equation:

$$K = \frac{16 \sqrt{2} π}{15} {( {η}_{s} {σ}_{s} {β}_{s} )}^{2} \sqrt{\frac{{σ}_{s}}{{β}_{s}}} \qquad ( 9 )$$

where σₛ is mean summit roughness, ηₛ is summit density, βₛ is mean summit radius.

Upon computing the contact pressure, the physics based model 160 further computes a ratio γ between an asperity load and a total load, which is represented as W_{α}/W, where W_{α} is the asperity load and W is the total load. The physics based model 160 further computes a bearing wear volume represented by the below equation, based on the ratio γ, the asperity load W_{α} and the total load W:

$$V = k ϕ \frac{{W}_{a} S}{H} = ( \frac{{( k ϕ )}^{′}}{H} ) ( \frac{WS}{H} ) = {k}_{l} * \frac{WS}{H} \qquad ( 10 )$$

where V is bearing wear volume, kφ is original Archard's coefficient, W_{α} is the asperity load, H is hardness, γ₂ is the scaling factor for asperity load, W is the total load, (kφ)′ is the fractional film defect coefficient, S is a sliding distance, and kₗ is a wear coefficient.

Furthermore, the physics based model 160 determines the change in thickness in the one or more layers 145 of the bearing 105 based on the bearing wear volume. The physics based model 160 computes an overlay thickness of the one or more layers 145 of the bearing 105 based on a bearing area and the bearing wear volume. As discussed herein, the term “bearing area” may be defined as a surface area of the bearing 105 formed by one or more layers 145 of the bearing 105. In one embodiment, the physics based model 160 computes the overlay thickness of the one or more layers 145 of the bearing 105 based on a predetermined value of the bearing and the bearing wear volume. As discussed herein, the term “overlay thickness” may be defined as a thickness of the one or more layers 145 of the bearing 105 after initial installation of the bearing 105. The overlay thickness of the bearing 105 is further compared with the predefined thickness of the one or more layers 145 of the bearing 105, to determine the change in thickness of the one or more layers 145 of the bearing 105. It should be noted herein that the predefined thickness is referred to as thickness of the one or more layers 145 of the bearing 105 at the time of manufacturing the bearing 105. Furthermore, loss of one or more metals particles of the bearing 105 in parts per million is computed based on the change in thickness of the bearing 105. In one embodiment, the loss of one or more eroded metal particles is compared with the concentration of the one or more eroded metal particles 180 measured by the metal particle sensor 190.

Furthermore, the physics based model 160 determines the estimated wear rate (d) of the bearing 105 based on the below equation:

δₑₛₜ=KVA*(p_{c}/πH)2Σᵢ(1/D)i4χi2/3 (11)

where δₑₛₜ is the estimated wear rate, K is calibration parameter, V is the sliding velocity between mating surfaces of the shaft and the bearing 105, A* is a real area ratio of contact between the mating surfaces, p_{c} is the asperity pressure, H is the hardness of the bearing 105, D is a particle size, and X is a particle volume concentration of one or more metal particles in the bearing 105. In the illustrated FIG. 1, the estimated wear rate is also represented by the reference numeral 150.

The controlling module 130 receives the plurality of sets of actual inspection data 140 and the estimated wear rate 150 to compute a calibration parameter 240. In the illustrated embodiment, the controlling module 130 includes a first controlling module 250 and a second controlling module 260. In a specific embodiment, the first controlling module 250 includes a bayesian estimation module. The first controlling module 250 receives the estimated wear rate 150 and the plurality of sets of actual inspection data 140 and adjusts the estimated wear rate 150 based on the plurality of sets of actual inspection data 140 to compute an actual wear rate 270. Specifically, the first controlling module 250 employs a predictor-corrector approach which uses the failure mode data such as the crack data, the creep data, and the actual change in thickness of one or more layers 145 of the bearing 105 from the predefined thickness, to determine an intermediate actual wear rate. Furthermore, the estimated wear rate 150 is modified based on the intermediate wear rate, to compute the actual wear rate 270. Furthermore, the processor 110 executes the second controlling module 260 which receives the actual wear rate 270 from the first controlling module 250 and computes the calibration parameter 240 based on the actual wear rate 270. The second controlling module 260 computes the calibration parameter 240 based on the aforementioned equation (11), wherein the estimated wear rate (δₑₛₜ) is replaced with the actual wear rate 270 and is represented by:

δ_{act}=KVA*(p_{c}/πH)2Σᵢ(1/D)i4χi2/3 (12)

where δ_{act} is the actual wear rate 270, K is a calibration parameter, V is the sliding velocity between mating surfaces of the shaft and the bearing 105, A* is a real area ratio of contact between the mating surfaces, p_{c} is the asperity pressure, H is the hardness of the bearing 105, D is a particle size, and X is a particle volume concentration of one or more metal particles in the bearing 105.

In equation (12) represented above, the actual wear rate 270 is represented as a function of the asperity pressure with respect to time (P(t)), hardness of the bearing 105 with respect to time (H(t)), and the calibration parameter (K), where K is also referred to as the wear rate coefficient. An initial value representative of the calibration parameter 240 is obtained from an experimental rig data. A rig based wear data is determined from the experimental rig data and then the initial value representative of the calibration parameter 240 is computed based on the rig based wear data. The estimated wear rate 150 and the actual wear rate 270 are computed based on the initial value representative of the calibration parameter 240 and aforementioned equations (11) and (12).

In one embodiment, the experimental rig data may include a fluid pressure, a fluid flow rate, velocity of the bearing 105, a bearing geometry, a metallic composition and properties of the bearing 105, fluid properties, operating time, a bearing hardness, a fluid temperature, Young's modulus of the bearing 105, and a bearing layer volume. The system 100 further includes a prediction module 280 stored in the memory 120 and executable by the processor 110, which is configured to predict a remaining useful life 290 of the bearing 105 based on the computed calibration parameter 240. In one embodiment, the prediction module may include a bayesian estimation module. As discussed herein, the term “remaining useful life” may be defined as an estimated time period for which the bearing 105 is capable of performing an intended function. The prediction module 280, when executed by the processor 110, receives the calibration parameter 240 from the controlling module 130 and predicts the remaining useful life 290 of the bearing 105. In a specific embodiment, the prediction module 280 predicts the remaining useful life 290 of the journal bearing in the locomotive 135. The prediction module 280 predicts the remaining useful life 290 of the journal bearing based on the calibration parameter 240 and the bearing inputs 230 which may include the operating time of the locomotive 135, the duty cycle of the locomotive 135, the average load of the locomotive 135 during operation time, and the average velocity of the locomotive 135. The prediction module 280 further provides guidance/inputs for a future use of the locomotive 135, which may include information pertaining to duty cycle, operating time, and average load.

The aforementioned method is performed iteratively by the system 100 over a period of time. Furthermore, at each cycle of the method performed by the system 100, the calibration parameter 240 is iteratively modified or updated by the controlling module 130. Such iterative modification of the calibration parameter 240 alters the value representative of the calibration parameter 240 towards unity, which further improves accuracy of prediction of the remaining useful life 290 of the bearing 105 by the prediction module 280. The aforementioned system 100 in accordance with the embodiment of the present invention, enables an owner of a fleet of the locomotives 135 to schedule maintenance of the journal bearings in the locomotives 135, based on the predicted remaining useful life, whereas in conventional methods, maintenance of the journal bearings is scheduled at fixed time intervals. The conventional methods lead to additional downtime and additional labor costs. In accordance with the embodiment of the present invention, additional downtime and labor costs are reduced because the maintenance of the journal bearings in the locomotives 135 is scheduled based on the predicted remaining useful life of the bearing 105. Similarly, the system and method for predicting the remaining useful life of the bearing may also be applied to gas turbines or any other application including journal bearings.

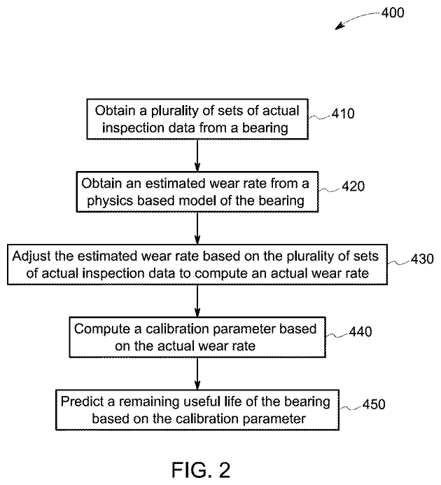

FIG. 2 is a flow chart representing a plurality of steps involved in a method 400 for predicting a remaining useful life of a bearing in accordance with an embodiment of the invention. The method 400 involves obtaining a plurality of sets of actual inspection data from a bearing 410. In one embodiment, a failure mode data is obtained from the bearing. In a specific embodiment, at least one of a crack data, a creep data, a tribology data, a corrosion data, and an actual change in thickness from a predefined thickness of one or more layers of the bearing is obtained. In a specific embodiment, a plurality of sets of actual inspection data is obtained from a journal bearing disposed in a locomotive. In another specific embodiment, a plurality of sets of actual inspection data is obtained at different intervals of time from a journal bearing disposed in a locomotive. In yet another specific embodiment, a plurality of sets of actual inspection data is obtained from a plurality of journal bearings disposed in a plurality of locomotives. In yet another specific embodiment, a plurality of sets of actual inspection data is obtained from a plurality of journal bearings disposed in a fleet of a plurality of locomotives. The method further involves obtaining an estimated wear rate from a physics based model of the bearing 420. In a specific embodiment, the estimated wear rate is computed based on a bearing input and an estimated change in thickness obtained from a predefined thickness of one or more layers of the bearing. In a more specific embodiment, a concentration of one or more metal particles eroded from the bearing is obtained and the estimated change in thickness from the predefined thickness of one or more layers of the bearing is determined based on the concentration of one or more metal particles eroded from the bearing. The method further involves adjusting the estimated wear rate based on the plurality of sets of actual inspection data to compute an actual wear rate 430. The method further involves computing a calibration parameter based on the actual wear rate 440. The method further involves predicting a remaining useful life of the bearing based on the calibration parameter 450.

It is to be understood that a skilled artisan will recognize the interchangeability of various features from different embodiments and that the various features described, as well as other known equivalents for each feature, may be mixed and matched by one of ordinary skill in this art to construct additional systems and techniques in accordance with principles of this disclosure. It is, therefore, to be understood that the appended claims are intended to cover all such modifications and changes as fall within the true spirit of the invention.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method comprising:
obtaining a plurality of sets of actual inspection data from a bearing;
obtaining an estimated wear rate from a physics based model of the bearing;
adjusting the estimated wear rate based on the plurality of sets of actual inspection data to compute an actual wear rate;
computing a calibration parameter based on the actual wear rate; and
predicting a remaining useful life of the bearing based on the calibration parameter.

2. The method of claim 1, wherein obtaining a plurality of sets of actual inspection data from a bearing, comprises obtaining a failure mode data from the bearing.

3. The method of claim 2, wherein obtaining a failure mode data from the bearing, comprises obtaining at least one of a crack data, a tribology data, a corrosion data, a creep data, and an actual change in thickness from a predefined thickness of one or more layers of the bearing.

4. The method of claim 1, wherein obtaining a plurality of sets of actual inspection data from a bearing, comprises obtaining the plurality of sets of actual inspection data from a journal bearing disposed in a locomotive.

5. The method of claim 4, wherein obtaining the plurality of sets of actual inspection data from a journal bearing disposed in a locomotive, comprises obtaining the plurality of sets of actual inspection data at different intervals of time from the journal bearing disposed in the locomotive.

6. The method of claim 4, wherein obtaining the plurality of sets of actual inspection data from a journal bearing disposed in a locomotive, comprises obtaining the plurality of sets of actual inspection data from a plurality of journal bearings disposed in a plurality of locomotives.

7. The method of claim 6, further comprising obtaining the plurality of sets of actual inspection data from a plurality of journal bearings disposed in a plurality of locomotives, comprises obtaining the plurality of sets of actual inspection data from the plurality of journal bearings disposed in a fleet of the plurality of locomotives.

8. The method of claim 1, further comprising obtaining a bearing input and computing the actual wear rate based on the bearing input.

9. The method of claim 1, wherein obtaining an estimated wear rate from a physics based model of the bearing, comprises computing the estimated wear rate based on a bearing input and an estimated change in thickness from a predefined thickness of one or more layers of the bearing.

10. The method of claim 9, wherein computing the estimated wear rate based on a bearing input and an estimated change in thickness from a predefined thickness of one or more layers of the bearing, comprises obtaining a concentration of one or more metal particles eroded from the bearing and determining the estimated change in thickness from the predefined thickness of one or more layers of the bearing based on the concentration of one or more metal particles eroded from the bearing.

11. A system comprising:
a processor;
a controlling module stored in a memory and executable by the processor, wherein the controlling module is configured to:
obtain a plurality of sets of actual inspection data from a bearing;
obtain an estimated wear rate from a physics based model of the bearing;
adjust the estimated wear rate based on the plurality of sets of actual inspection data to compute an actual wear rate;
compute a calibration parameter based on the actual wear rate; and
a prediction module stored in the memory and executable by the processor, wherein the prediction module is configured to predict a remaining useful life of the bearing based on the calibration parameter.

12. The system of claim 11, wherein the bearing comprises a journal bearing.

13. The system of claim 12, wherein the journal bearing is disposed in a locomotive.

14. The system of claim 12, wherein the bearing comprises a plurality of journal bearings disposed in a fleet of locomotives.

15. The system of claim 12, wherein the journal bearing comprises a trimetal bearing, or a sputtered bearing, or a Rillenlager bearing.

16. The system of claim 11, wherein the controlling module comprises a first controlling module and a second controlling module.

17. The system of claim 16, wherein the first controlling module comprises a bayesian estimation module configured to adjust the estimated wear rate based on the plurality of sets of actual inspection data, to compute the actual wear rate.

18. The system of claim 11, further comprising a metal particle sensor for determining a concentration of one or more metal particles eroded from the bearing.
